(19) United States
(12) Patent Application Publication
(10) Pub. No.: US 2015/0304540 A1
(43) Pub. Date: Oct. 22, 2015

(54) SYSTEM ALLOWING USERS TO INTERACT WITH ANIMALS, BOTH REAL AND SIMULATED

(71) Applicants: Andrew Breckman, Madison, NJ (US); Stephen R. Curtin, Edison, NJ (US)

(72) Inventors: Andrew Breckman, Madison, NJ (US); Stephen R. Curtin, Edison, NJ (US)

(21) Appl. No.: 14/689,249

(22) Filed: Apr. 17, 2015

Related U.S. Application Data
(60) Provisional application No. 61/981,306, filed on Apr. 18, 2014.

(51) Int. Cl. H04N 5/232; A01K 29/00; H04N 5/247; A01K 5/00

(52) U.S. Cl. CPC H04N 5/23206; A01K 5/00; A01K 29/00; H04N 5/23216; H04N 5/23293; H04N 5/247

(57) ABSTRACT

The present disclosure provides for methods and systems of remote interaction. Preferably, one remotely interacts with a non-human animal. The animal is preferably housed in a rescue or adoption type shelter, but may be present in any particular location. A video feed allows individuals to view and subsequently interact with the animals via an electronic device and communications network. For example, a user may have the option to feed the animal via an interactive unit located at the shelter. The user may also be able to interact with the animal remotely via commands or with the assistance of the shelter staff or other individuals at the remote location. In some instances, sounds may be transmitted from either location to the other. These interactions are achieved using an electronic device preferably running a web or mobile application permitting access to the system through a communications network.

### CLAIM OF PRIORITY

This application claims priority to U.S. Application 61/981,306 filed on Apr. 18, 2014 the contents of which are herein incorporated by reference in its entirety.

### FIELD OF THE EMBODIMENTS

The field of the invention generally pertains to methods and systems for remotely interacting with a person or animal at a remote location. In particular, the present invention relates to methods and systems using an electronic device that enables a remote user to feed a real animal and further interact with the aforementioned animal.

### BACKGROUND OF THE EMBODIMENTS

Nowadays, it is extremely common for households to have pets and many households often have more than one pet. It is also not unusual for a family to have multiple pets of different breeds or different species. Statistics show that the two most popular pet types are cats and dogs. According to recent figures by the Humane Society of America, there are about 78.2 million dogs and about 86.4 million cats being kept as pets in the United States alone. Figures suggest that pets outnumber children in this country four to one.

Many people and households keep any number of pets as these companion animals commonly provide their owners with both physical, emotional, and/or mental benefits. For example, walking a dog can supply both the human and animal with exercise, fresh air, and social interaction. Pets can give companionship to elderly adults who do not have adequate social interaction(s) with other people. Even yet, there is a medically approved class of therapy animals, mostly dogs or cats that are brought to visit confined humans. Such animal therapy utilizes trained animals and handlers to achieve specific physical, social, cognitive, and emotional goals with patients. Thus, pets can provide many benefits and give many people a greater quality of life.

Unfortunately, notwithstanding the above, it has become increasingly common for pets to be removed from a household for one reason or another. Many times people find they are ill-equipped to provide adequate care for an animal or they must move to a different dwelling and cannot take the animal with them. In some instances, people are not able to provide the adequate financial support to sufficiently care for the animal's needs. Thus, even if the conditions are not right to keep a pet in the home, there is a need to provide these human-animal interactions to reap the benefits. The present invention and various embodiments contained herein meets and exceeds these objectives.

### REVIEW OF RELATED TECHNOLOGY

U.S. Pat. No. 8,588,968 pertains to a system and method for remotely dispensing a pet treat using an Internet-accessible treat dispensing apparatus including the steps of: (1) providing a dispensing apparatus including: a treat dispensing unit with a mechanism for sliding a delivery plate over a stationary base plate; a control circuit electronics portion in communication with the sliding mechanism and with a router or a local computer, which is in communication with at least one remote Internet-accessible electronic device; and video camera portion(s); (2) providing a webpage or website that can be viewed using the local computer or the Internet-accessible electronic device; (3) displaying a prompt on the webpage for inputting user information; (4) displaying a control block with a treat button for dispensing the treat; (5) initiating a video camera view; (6) displaying a delay button for delaying the treat; and (7) sending a signal to initiate the sliding mechanism, followed by automatically dispensing the treat. This simplified abstract is not intended to limit, and should not be interpreted as limiting, the scope of the claims.

U.S. Pat. No. 8,201,522 pertains to a phone for pets and pet owners which allows the owner to call the house and “talk” to the pet. The owner can then see a video image of the pet in front of the pet phone to verify presence and happiness. The device can also present the owner's scent to the pet and deliver treats on remote command. In some embodiments, the pet can initiate the phone call.

U.S. Patent Application 2013/0319338 pertains to methods and systems for human-pet communication. Example embodiments provide for an Internet Canine Communication System (“ICCS”). The ICCS facilitates remote communication and interaction with between a dog and its owner, caretaker, trainer, family member, or the like. The ICCS may include a base station or similar device that is configured to deliver treats to a dog and to transmit audio/visual communication between the dog and a remote client device operated by a human user. The ICCS may also facilitate training the dog to utilize the ICCS to communicate with the user, such as by answering calls from or initiating calls to the remote client device of the user.

U.S. Patent Application 2013/0198175 pertains to a system that allows users seeking to adopt to search based on the desired attributes of an animal and the availability of such animals. It allows a user to determine the breed they most prefer adopt. Once an animal is selected, a live feed of the animal can be viewed. If the user wants to adopt, the system electronically provides an application which the system forwards to the shelter where the animal is located for review. Revenues collected from advertising and donations are automatically shared with the shelters through the system. The system acts as to facilitate intra-shelter transfers and as a lost and found. It allows shelter administrators to manage volunteers, fosters and staff. It provides a single user-accessible location to store medical history and other records relating to the adopted pet. It can notify the user when an animal of the desired breed becomes available.

Various devices are known in the art. However, their structure and means of operation are substantially different from the present disclosure. The other inventions fail to solve all the problems taught by the present disclosure. The present disclosure provides for a web and/or mobile based application that allows a user to interact with a remote animal. Having options available, such as at least to feed the animal, provide for the animal's well-being. Such interactions may occur in real-time or may be pre-recorded. At least one embodiment of this invention is presented in the drawings below and will be described in more detail herein.

### SUMMARY OF THE EMBODIMENTS

The present invention and its embodiments generally describes a system and method by which remote user(s) can interact with an animal at a remote location. The system employs live video streams and pre-recorded video to enable the remote user to feed, play, and otherwise interact with the animal. The user, however, is unable to ascertain whether the video is live or pre-recorded.

It is preferable that the user uses a mobile or web based application with varying control options to listen to and interact with the animal at the remote location. The user may be able to purchase items such as toys, food, and the like to use in interactions with the animal. Thus, if a user selects to feed the animal a treat, a treat is shown, via the user's electronic device, with the animal subsequently eating the treat. The application may have other functionalities such as sharing of application based activities and inviting more patrons to use the application.

In one embodiment, there is a method of remote interaction comprising the steps of: providing, at a first site, at least one image capturing device having an optical sensor and being operably connected to an electronic communication point capable of being connected to a communication network; providing, at a second site, an electronic device capable of accessing the communication network; displaying at least one touch sensitive button on the electronic device; displaying a representation of the first site on the electronic device; and a remote user activating the at least one touch sensitive button to interact with the first site.

In another embodiment, the present disclosure describes and teaches a method of interaction having at least the steps of: providing, at a first site, at least one interactive unit having a transport mechanism, and a serving area, an electronic communication point providing access to a communications network, and at least one image capturing device having an optical sensor and being operably connected to the electronic communication point; providing, at a second site, an electronic device capable of accessing the communication network; displaying at least one command button on the communication network; capturing a representation of the second site; displaying the representation on the electronic device; and a remote user activating the at least one command button to interact with the second site.

The method may further include (in singularity or any combination thereof) the steps of the remote user viewing on the electronic device the interaction resulting from the activation of the at least one command button, the remote user selecting the same or a different interaction corresponding to the at least one command button, the remote user changing the displayed image capturing device based on user defined preferences or user defined constraints to interact with a different entity at the same or a different location; and the remote user selecting the at least one command button to interact with the different entity.

In another aspect of the invention, the present disclosure describes and teaches a system having a plurality of interactive units at a plurality of separate locations with each interactive unit having at least a transport mechanism and a serving area, wherein the interactive unit dispenses food items to the serving area via the transport mechanism, at least one electronic communication point operably connected to the plurality interactive units at each of the plurality of separate locations, and a plurality of image capturing devices operably connected to each of the at least one electronic communication point; and an electronic device capable of accessing to the electronic communication point via a communications network.

Generally, the above described embodiments and others describe a system using a web or mobile based application to interact with a remotely located entity, preferably an animal. By using an electronic device, such as a computer, tablet, or smart phone, one can access the system and gain remote access to the animal. The application interface enables various actions to be carried out by the interactive unit located at the remote location. There can be any number of interactive units located at any number of remote locations. This enables a user to interact with an animal without actually having to care and be responsible for that animal.

Additionally, most interactions take place via a pre-recorded feed of a time-varying image, or video. Various interactions are recorded and stored on a server. In some instances, the feed is live and the user is actually interacting with the animal in real time. However, as noted, the user cannot tell the difference between a pre-recorded and live feed. The system, for pre-recorded feeds, simply cues up the appropriate video feed corresponding to certain interactions. This ensures the safety of the animals (i.e. cannot be overfed) as well as providing entertainment for the users. The interactions are all real just not necessarily in real time.

In general, the present invention succeeds in conferring the following, and others not mentioned, benefits and objectives.

It is an object of the present invention to provide a method of remote interactions between locations.

It is an object of the present invention to provide a method that supports animal shelters and the like.

It is an object of the present invention to provide a method of providing food to an animal from a remote location.

It is an object of the present invention to provide a method of interaction that provides for video feeds linking two remote locations.

It is an object of the present invention to provide a method that provides increased cash flow for animal housing facilities such as shelters and zoos.

It is an object of the present invention to provide a system that has an interactive unit capable of interacting with the animal at the remote location.

It is an object of the present invention to provide a system that enables vocal communication between locations.

It is another object of the present invention to provide a system that transmits information via a communications network.

It is an object of the present invention to provide a system that enables users to interact with a remote location in real-time or via a pre-recorded feed.

### BRIEF DESCRIPTION OF THE DRAWINGS

FIG. 1 is an overview of the system architecture of an embodiment of the present invention.

FIG. 2 is a block diagram illustrating the interrelationship of the varying components and capabilities of the system of the present invention.

FIG. 3 is a representation of an interface of a remote user's electronic device according to the present invention.

FIG. 4 is a flow chart outlining a method of interacting with the system of the present invention.

### DETAILED DESCRIPTION OF THE DRAWINGS

The preferred embodiments of the present invention will now be described with reference to the drawings. Identical elements in the various figures are identified, as far as possible, with the same reference numerals.

Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

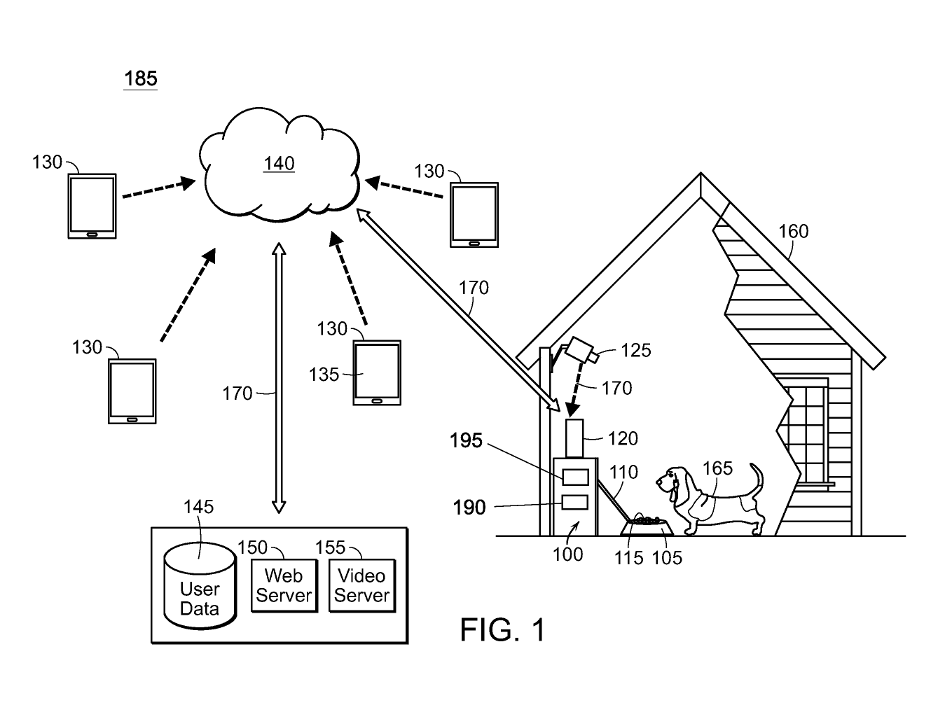

Referring now to FIG. 1, there is an overview of the system architecture of an embodiment of the present invention. Through this system, a user can interact with an animal, either human or non-human, at a remote location. Thus, users interact with non-animals either owned by others or not owned (i.e. animal in a rescue shelter). On one end of the system there is an interactive unit 100 at a first location 160, and the other end of the system there is an electronic device 130 at a second location 185.

The interactive unit 100 has a number of components including a transport mechanism 110, serving area 105, image capturing device 125, and an electronic communication point 120.

The electronic communication point 120 may be any apparatus capable of enabling communication over a variety of protocols including wireless communications protocols (e.g. Wi-Fi®, Bluetooth®, etc.), wired communications protocols (e.g. LAN, WAN, etc.), satellite communications, and mobile telecommunications technology, and the like or any combination thereof. In a preferred embodiment, there is a router implementing one or more of these technologies with port forwarding. In some implementations, a router that operates on multiple bands (dual band, tri-band, quad-band, etc.) is preferred.

Depending on the particular system configuration, there may be one or more than one interactive unit 100 at the first location 160. The interactive unit 100 may further have a sound emitting device 190 and a sound capturing device 195. The sound emitting device 190 may be embodied as a speaker and the sound capturing device 195 may be embodied as a microphone. This permits for the exchange of sounds between the first location 160 and the second location 185. The user may be able to give verbal commands to the animal 165, as well as hear the animal make sounds as well. Such interactions may also be pre-recorded by the system enabling the user to still hear the animal if not interacting with the animal in real time.

Further, in some embodiments, the interactive unit 100 may be capable of throwing or launching objects for retrieval by the animal 165. In other iterations, the interactive unit 100 may be capable of placing held objects in varying positions, so as to play “tug of war” with the animal 165. Other forms of animal interaction are also envisioned within the bounds of the interactive unit 100.

Additionally, the first location 160 only refers to the end of the system which houses the interactive unit 100. Thus, there may be any number of first locations 160 housing any number of interactive units 100. The first location 160 is preferably an animal rescue/adoption type shelter run by any number of organizations. The interactive unit 100 is designed to be interacted with remotely from a second location 185. From the second location 185, a remote user can interact with the interactive unit 100 via an electronic device 130. The second location 185 can be any location where the user of the web based or mobile based application is located. This can include at home, school, work, outside on a walk, and the like. This application brings the animals to the user, thus the user does not need to own or have any obligation to the animals located at the first location.

At the first location 160, there is an animal 165 for the remote user to preferably interact. The first location 160 may be any number of places capable of keeping, housing, and caring for an animal including homes, rescue/adoption shelters, schools, stores, zoos, and the like. The type of animal 165 may also vary as well as may include at least any type of mammal, bird, reptile, amphibian, fish, and invertebrate.

At the first location 160, the interactive unit 100 is set up in a particular area as best suited for the animal 165. This location may be within or outside an enclosure or structure in which the animal 165 is held. The interactive unit 100 can serve a number of functions including entertaining the animal 165 and feeding the animal 165. As shown in FIG. 1, there is a transport mechanism 110 extending from the interactive unit 100. This carries or otherwise causes the food 115 to be delivered from the interactive unit 100 to the serving area 105. The serving area 105 is shown as a dish but may generally be a location in the animal's enclosure. The transport mechanism 110 may comprise any type of mechanism that facilitates in delivering an item, including food 115, to the animal 165. Thus, the transport mechanism 110 may be a conveyor, a gravity drop, a tube, or the like or any combination thereof.

There is an image capturing device 125 that is operably connected to the interactive unit 100 and further the electronic communications point 120. The image capturing device 125 is any device capable of capturing a static or time varying image of the first location 160. It is preferable that such an image capturing device 125 is readily mountable and has point, tilt, and zoom capabilities. The device may stream video over a signal 170 and capture and store video to an on-board or off-site storage device. The signal 170 may comprise a network connection capable of maintaining an average of at least 2 mbps to send video and other data between points within the system. The electronic communications point 120 may implement network bandwidth management planning to attempt to ensure that sufficient resources are being allocated to the image capturing device 125 to avoid buffering or lost packets of video stream and other data. The image(s) may be collected in varying video compression formats including but not limited to h264.

The image capturing device 125 may have a number of sensors including at least an optical sensor and/or a motion sensor. The motion sensor allows the image capturing device to automatically follow detected movement in order to keep a moving object in frame. The images captured are sent via a signal 170 to the electronic communications point 120. The electronic communications point 120 is preferably a router capable of communicating with a communications network 140. The communications network 140 may be a public, private, or the like enabled network that transports information in varying (e.g. encrypted, unencrypted, etc.) formats. The type of connection may be dictated by a service provider or may be selectable by the user.

At a second location 185, there are any number of electronic devices 130 that are capable of communicating with a communication network 140. The electronic devices 130 may comprise laptop computers, desktop computers, smart phones, gaming systems, PDAs, and the like or any combination thereof. The electronic devices 130 may have an interface 135 that enables interaction with the interactive unit 100. The interface 135 may enable commonly known features such as visual and auditory cues as well as vibrational feedback. The interface 135 may be touch sensitive.

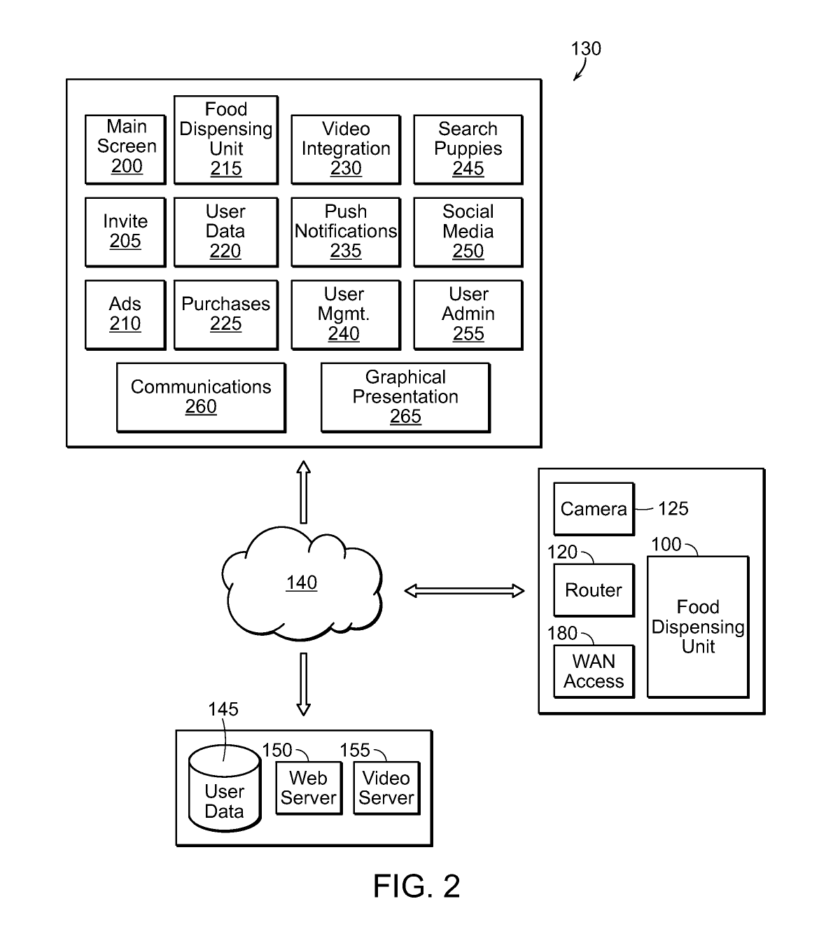

In FIG. 2 there is block diagram demonstrating the various capabilities of the system. At a first location the interactive unit 100, image capturing device 125, electronic communications point 120, and WAN access 180 are shown. As noted, this WAN access is only illustrative and other protocols including but not limited to LAN, WLAN, PAN, and the like may be implemented. At the second location, the electronic devices 130 are shown. In one instance, the electronic device 130 is a host server providing a web based server 150. The system may utilize a centrally located web server connected to the communication or other network as described herein. The web server 150 may manage, amongst other functionality, the video streams, feeding mechanisms, user inventory, and all configurable aspects of the system.

Further, the electronic device 130 may track user data 145 and provide a video server 155. The user data 145 and video server 155 are stored on the server. The user data 145 is stored on the server to track user actions in interacting with the mobile or web based application. Server databases such as MySQL server may store data on the web server 150. Further, the user data 145 comprises data associated with user accounts such as log-in credentials and the like. The video server 155 provides off-site storage of recorded video to be presented to users running the web or mobile based application. Further, the system may utilize a content delivery network that provides live streaming video and video on demand services. By integrating both types of video services, the user of the system, as a whole, is unable to distinguish between live video and prerecorded video when accessing the system.

The electronic device 130 may also be a smart phone, gaming system, PDA, laptop computer, desktop computer, smart watch, multimedia player, or the like. The electronic device 130 preferably runs a mobile application that interacts with the system and enables the user to interact with the first location. Any combination of screens and functionality can be tied to the mobile application including a main (splash) screen 200, invitation mode 205, advertisements 210, interactive unit button 215, user data 220, user purchases 225, video integration 230, push notifications 235, user management 240, search 245, social media interactions 250, user administration 255, communications 260, and graphical presentation 265.

The main screen 200 or splash screen is the screen that may first greet a remote user when accessing the system through, for example, a mobile application. This screen may allow for display of animals for viewing/feeding, locations of animals, and other information relating to the system. Through the invite functionality 205, remote users who have signed up to access the system may invite their friends, family, etc. to sign up and use the system and application as well. There may be any number of methodologies to achieve this invite functionality. For example, a user could send a text invite to another. By selecting a text invite option, a native OS compose SMS may open. A message body having a download link to the mobile application store or a website associated therewith may be pre-populated in this message. A user can select from people within their phone/device contact list, edit the message, and subsequently send the message.

In another example, a user may send a social media based invite. The system may allow for sharing across all of the popular social media channels including Facebook, Twitter, Google+, Instagram, Pinterest, Tumblr and others as needed. By selecting this option, an authenticated connection to the specific channel and the social media box for sharing may be opened. A message body having a link to the application store or an associated website may be pre-populated in this message, along with, in some cases, a photo of the last puppy/animal viewed. A user can then click on the post button and the invite is broadcast across that user's social media network.

A remote user who refers friends may receive perks for use with the system as a reward for facilitating sign ups. Advertisements 210 may also be shown periodically to the remote user. The advertisements 210 may comprise new windows, videos, images, or some combination thereof that the user encounters when using the application. The advertisements 210 may be able to be temporarily or permanently removed from the application by the remote user paying a nominal fee. In some instance users may be able to turn off the advertisement for a fee, or the users can view advertisements to earn credits such as treats to be used in conjunction with the system.

There are a number of functionalities tied to the user's account and access to the system. The mobile application logs user data 220. The user data 220 may comprise any number of factors including time spent on the application, money spent on the application, various actions taken, ads viewed on the application, ads click-throughs on the application, time of day of usage, and any other data deemed pertinent. The user data may be used to create more targeted advertising and an overall more enjoyable user experience by catering to the user's preferences. The user management 240 and user administrative 255 blocks provide the avenues for the user to control account settings, usernames, passwords, and the like.

The user may search for particular animals 245 using a search function. The user may be able to filter the searches based on criteria such as type, age, species, breed, health, sex, and the like. In turn, the searches or particular animals may be able to be saved by the user. This allows for the use of targeted push notifications 235 to be received by the user.

In one embodiment, the system calls the particular animals' list web service, to retrieve the information required for the main screen 200. The web service may transmit the information in batches, and utilize caching to minimize the amount of time it takes to display and scroll through the list of animals. The number of animals to be displayed on an electronic device may be determined by the screen size of the device, with the application or website dynamically adjusting based upon the electronic device 130.

As noted above, a user can search for puppies, or other animals, based upon multiple keyword such as name, description, location city, location state, location country. If a match is found, the application will display the matching animal(s).

The push notifications 235 may alert the user to the actions of a particular animal or make note of new animals fitting the user's criteria. The push notification 235 may be controlled by the user as to the frequency and manner of their display. The system or application may send notifications to users to notify them of new animals, new application features, advertisements, and other various information. This information can be broadcast to all users or sent to individual users based on a variety of criteria. In one embodiment, when a user opens the application for the first time, a web service is invoked to send the device identifier (ID) to web server 150. The web service stores this device ID in the web server database along associated with any user information. The user can then further interact with various social media sites 250 by selecting the corresponding icon. Thus, a user can alert others to a particular animal or their interactions with that animal made via app features or in-app purchases 225.

The in app purchases may comprise feeding the animal, playing with the animal, donating money to the animal, and so forth. Some of the in application purchases 225 may be used to permit access to features that non-purchasers do not have.

By selecting the interactive unit 215, the image capturing device is activated and the image captured feed is displayed on the electronic device. The mobile application and/or web application further has video integration 230 which allows for the transfer of video between the first location 160 and the second location 185. The video integration 230 may employ multiple bit rate streams to support users having low bandwidth or other technical limitations. The communications 260 block further provides for seamless data transfer.

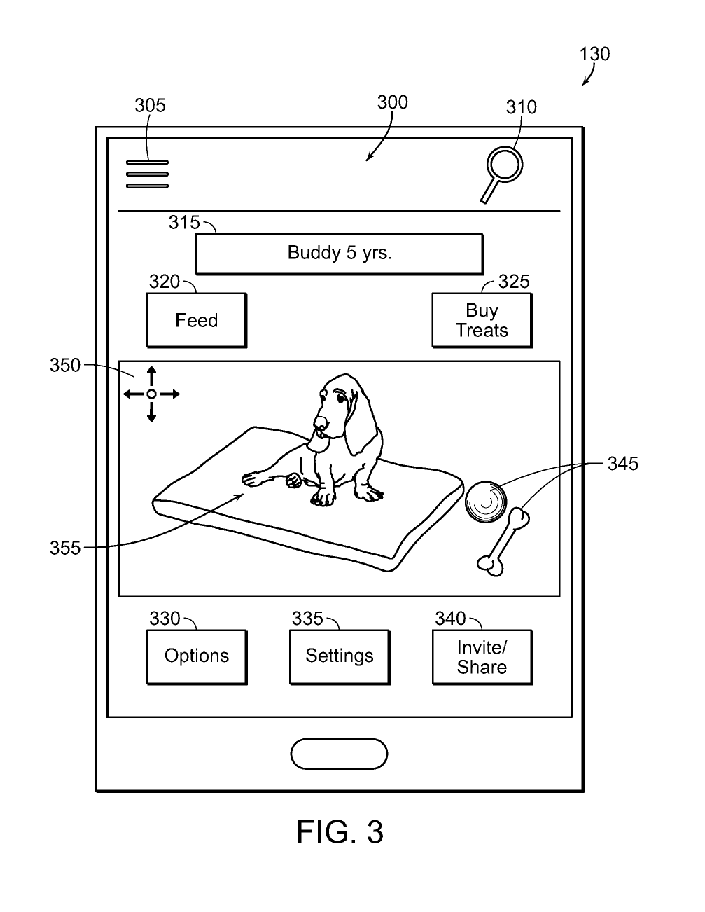

In a FIG. 3 there is an illustrative example of a typical screen associated with the application and system as viewed by the remote user. This sample screen is intended to serve as one embodiment of the screen and other embodiments may exist with the same or different functionality.

In this embodiment, an electronic device 130 is shown having accessed the system typically through a mobile application, web application, or the like. The interface includes a menu bar 300. The menu bar 300 may provide at least a menu tab 305 and a search function 310. The menu tab 305 may open a navigational menu that can take the remote user to any particular screen associated with the mobile application or web application. Thus, the screens referred to in FIG. 2 may all or partly be navigable through the menu tab 305. The search function 310 may open a search menu through which the remote user can enter any combination of search terms to help find the particular topic of interest. The search function 310 may have an option to search the mobile application only or may allow for enhanced searching through a communications network via third parties.

The mobile application preferably provides an animal information bar 315 which provides information about the animal 355 currently being viewed. Information may relate to the name, age, sex, health, health history, allergies, disposition, and the like or any combination thereof. This information may also be searched through filters to find animals with characteristics meeting the user's desires. A feed button 320 is used to control the interactive unit 100 (see FIG. 1) and dispense food items. In other instances, the feed button 320 is used to cue a particular pre-recorded video and/or video segments in order to simulate a “live” feeding. The feed button 320 may be accompanied by a message, upon selection, to confirm the selection. Additionally, such a selection may result in the user incurring a cost to their account associated with their wireless provider or the application itself. The same holds true for the treat button 325, which may be used to supply the animal with a different food item.

Each interaction type button (i.e. feed, treat, throw, etc.) may have a built-in “fail safe.” This prevents one from over feeding an animal or doing things that would be deemed inappropriate. For example, if someone tried to feed an animal more times than is necessary, the pre-recorded video may override any live video feed of the same animal. Thus, while it would appear a user is feeding the animal multiple times, in reality they are watching a pre-recorded looped feed and the animal has only been fed once. In other embodiments, the user receives a warning that the animal just ate and cannot be fed again until a predetermined or some other time period.

The same principle can hold true for giving the animal treats, or throwing toys for the animal via the interactive unit. In many cases, the pre-recorded feed will be cued up automatically and the user will not be able to discern whether or not the feed is live or pre-recorded. Any of the pre-recorded feed comes from previous interaction captured and saved by the system. The application, as described herein, will track the viewing of certain pre-recorded videos or video segments to ensure that the user is not shown the same video in succession in order to further create the illusion of interacting with a live animal.

The options button 330 can bring up the options menu by which has any and all options or user preferences for the web or mobile application. The settings button 335 may be similar to the options button 330 and only one of the two may exist on any given interface. The settings button 335 may also be used to control more functionally based settings than the options button 330. The invite/share button 340 is used to invite people to join and/or use the mobile application and to share certain aspects of the application with social media. For example, by selecting the “Facebook” button one may be able to post to Facebook alerting others that they just played with and fed a particular animal. Each of these buttons, as described, may reside on the interface itself or may be located in the menu tab 305 as described.

The interface displays the image captured by the image capturing device 125 (see FIG. 1). Various environmental objects may be shown such as toys 345 and other environmental or interactive objects. The animal 355 in this case, a dog, is shown. The user may be able to manipulate the view by using the directional arrows 350 present. By depressing any of the directional arrows 350, the view captured from the image capturing device, or camera, can be manipulated. While this may limit one to left, right, and up or down motions, there may be more than one image capturing device capable of seeing a particular animal. Thus, in some embodiments, one may be able to change cameras to get a different angle of which they would also be able to move up/down, left/right.

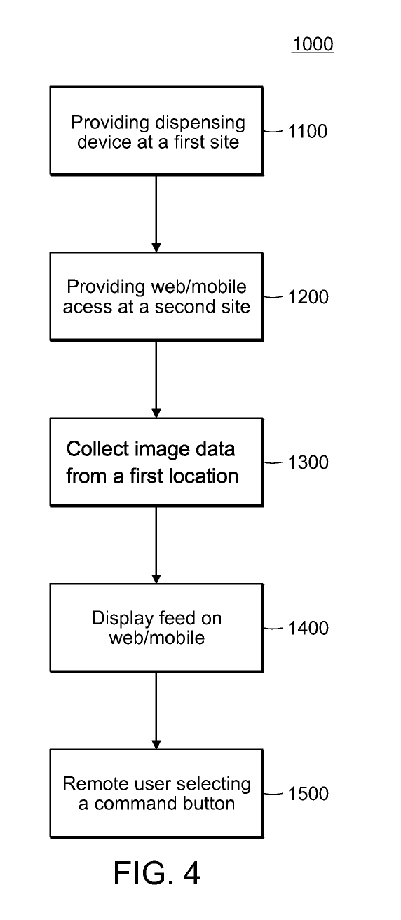

In FIG. 4 there is a flowchart outlining a general method 1000 of interacting with the system described above.

In a box 1100, an interactive unit is provided at a first location. The interactive unit of the system enables interaction on a variety of levels including feeding and playing with an animal. The interactive unit may contain a variety of functioning components and may be permanent or removable.

For example, the interactive unit may be set up and used in an animal shelter or other location to collect the required video for storage and later use. The interactive unit is then removed from the location once sufficient video has been captured. In other embodiments, the interactive unit remains and can be used to interact with the animal in real time. As long as an interactive unit is present, a user may be capable of interacting with that animal in real time.

In a box 1200, an electronic device is provided at a second location that is capable of communicating, either wired or wirelessly, with the interactive unit via a communications network. The electronic device may interact directly with the interactive unit thereby by-passing the communications network. The electronic device may be a smart phone, tablet, lap top computer, desktop computer, smart watch, multimedia player, gaming system, and the like or any combination thereof.

In a box 1300, an image capture is initiated by the system at the first location. The captured image may be a static or time varying image and may be taken in real time or be pre-recorded and accessed by the system. Thus, a user may be viewing a live camera feed from the remote location, or may be receiving a pre-recorded video or video segments from the video server.

In a box 1400, the captured image is displayed on the electronic device at the second location.

The remote user can then, at a box 1500, interact with the captured image via the electronic device. The user interacts with the animal at least as described above with regard to FIG. 3. Other interactions and functionality not explicitly specified therein may also be available to the user.

When the user accesses the system through the web or mobile based application, they can view a static or time varying image of the particular remote location. A static image would typically be viewed as a still image or a picture/photograph, whereas a time varying image would be a live video feed.

Depending on a number of factors, including number of available animals, times fed, and the like, the user may receive a live static or time varying image or a pre-recorded static or time varying image. If the image is a live image, the user is indeed interacting with the animal in real time. Thus, they are actively feeding and interacting with the animal.

In some instances, a user is shown a pre-recorded static or time varying image. In these instances, the user can interact with the animal just as one would with the real time image. The difference being, of course, that all the actions are pre-recorded. For example, in one embodiment, in displaying the simulated or pre-recorded animals, the application utilizes more than 10 and as many as 100 or more pre-recorded video segments. For data storage purposes it is preferred this number be about 40 to about 50 prerecorded video segments per animal.

In another embodiment, all video segments are downloaded onto the mobile device. In yet another embodiment, discrete video segments are not used but rather use a single video hosted on a video server with logical start and stop points within the video is employed. Thus, in this embodiment, each video may have a dog or other animal playing, followed by food dispensing, and the dog or other animals eating.

When a user selects an animal that is simulated, the application may use a randomization method to select a segment at random for streaming. The application may further keeps track of which video segments each individual user has viewed and the next time that user selects the same animal, a different random segment is then streamed. The video segments include but are not limited to the animal before feeding, the animal eating the treat, the animal after feeding, the animal playing, and the animal sleeping.

Thus, when a user hits the “feed” button, the system cues and displays the pre-recorded static or time varying image as if it were occurring in real time. This process can occur for any number of interactions and is invisible to the user. The user, as noted above, cannot tell if they are receiving a live or pre-recorded static or time varying image. Regardless of the image type shown, any in application charges associated with the interactions still apply.

What is claimed is:

1. A method of remote interaction comprising the steps of:
providing, at a first site, at least one interactive unit comprising,
a transport mechanism and a serving area,
an electronic communication point providing access to a communications network, and
at least one image capturing device having an optical sensor and being operably connected to the electronic communication point;
providing, at a second site, an electronic device capable of accessing the communication network;
displaying at least one command button on the communication network;
capturing a representation of the first site;
displaying the representation on the electronic device; and
a remote user using the at least one command button to interact with the first site.

2. The method of claim 1 wherein the at least one command button enables the remote user to activate the at least one interactive unit thereby providing at least one food item to the first site.

3. The method of claim 1 further comprising the step of:
the remote user viewing on the electronic device the interaction resulting from the activation of the at least one command button.

4. The method of claim 1 further comprising the step of:
the remote user selecting the same or a different interaction corresponding to the at least one command button.

5. The method of claim 1 wherein the representation of the first site is a static or time varying image.

6. The method of claim 5 wherein the static or time varying image is captured in real time or is pre-recorded.

7. The method of claim 1 further comprising the steps of:
the remote user changing the at least one image capturing device based on user defined preferences or user defined constraints to interact with a different entity at the same or a different location; and
the remote user selecting the at least one command button to interact with the different entity.

8. A system of remote interactions comprising:
at least one interactive unit comprising,
at least a transport mechanism and a serving area,
an electronic communication point providing access to a communications network, and
at least one image capturing device operably connected to the electronic communication point; and
an electronic device capable of accessing the electronic communication point via the communications network.

9. The system of claim 8 wherein the electronic communication point is a router.

10. The system of claim 8 wherein the at least one interactive unit contains food items to be dispensed individually or in plurality.

11. The system of claim 8 wherein the at least one image capturing device provides a view of the serving area.

12. The system of claim 8 wherein the at least one image capturing device can be controlled remotely via the electronic device.

13. The system of claim 8 wherein a remote user can interact with the at least one interactive unit via the electronic device.

14. The system of claim 8 wherein the image capturing device further comprises a motion activated sensor.

15. The system of claim 14 wherein the motion activated sensor automatically tracks sensed movement thereby automatically following the sensed movement with the image capturing device.

16. A system for remote interactions comprising:
a plurality of interactive units at a plurality of separate locations with each interactive unit comprising,
at least a transport mechanism and a serving area,
wherein the interactive unit dispenses food items to the serving area via the transport mechanism,
at least one electronic communication point operably connected to the plurality interactive units at each of the plurality of separate locations, and
a plurality of image capturing devices operably connected to each of the at least one electronic communication point; and
an electronic device capable of accessing to the electronic communication point via a communications network.

17. The system of claim 16 wherein the electronic device is wired or wireless.

18. The system of claim 16 wherein there is at least one image capturing device per interactive unit at each of the plurality of separate locations.

19. The system of claim 16 wherein the electronic device provides an interface that enables a remote user to interact with any of the plurality of interactive units.

20. The system of claim 19 wherein the remote user can actively choose with which interactive unit to interact.

21. The system of claim 20 wherein the particular interactive unit is chosen based on predefined user preferences.

22. The system of claim 16 wherein the plurality of interactive units are capable of throwing an object for retrieval.

23. The system of claim 16 wherein the plurality of interactive units are capable of placing held objects in varying positions.

24. The system of claim 16 wherein the plurality of image capturing device contain at least one of an optical sensor and a motion sensor.

25. The system of claim 16 further comprising a sound collecting device.

26. The system of claim 25 wherein the sounds collected by the sound collecting device are transmitted to the electronic device.

27. The system of claim 16 further comprising a sound emitting device.

28. The system of claim 27 wherein the sound emitting device emits pre-recorded sounds or sounds in real time.

29. The system of claim 24 wherein the optical sensor captures a static or time varying image of any of the plurality of separate locations.

30. The system of claim 29 wherein the static or time varying image is captured in real time or is pre-recorded.

31. A system for remote interactions comprising:
a plurality of interactive units at a plurality of separate locations with each interactive unit comprising,
at least a transport mechanism and a serving area,
wherein the interactive unit dispenses food items to the serving area via the transport mechanism,
at least one electronic communication point operably connected to the plurality of interactive units at each of the plurality of separate locations,
a plurality of image capturing devices having an optical sensor and being operably connected to one of the at least one electronic communication point,
at least one sound collecting device, and
at least one sound emitting device; and
an electronic device capable of accessing to the electronic communication point via a communications network.

32. The system of claim 31 wherein each of the at least one sound collecting device and the at least one sound emitting device are operably connected to at least one of the communication points.

33. The system of claim 31 wherein the sounds emitted by the sound emitting device are generated by a remote user of the system.

34. A method of remote interaction comprising the steps of:
providing, at a first site, at least one image capturing device having an optical sensor and being operably connected to an electronic communication point capable of being connected to a communication network;
providing, at a second site, an electronic device capable of accessing the communication network;
displaying at least one touch sensitive button on the electronic device;
displaying a representation of the first site on the electronic device; and
a remote user activating the at least one touch sensitive button to interact with the first site.

35. The method of claim 34 wherein the representation is a live video stream.

36. The method of claim 34 wherein the representation is a pre-recorded video stream.

37. A method of remote interaction comprising the steps of:
providing, at a first site, at least one image capturing device having an optical sensor and being operably connected to an electronic communication point capable of being connected to a communication network;
providing, at a second site, an electronic device capable of accessing the communication network;
displaying at least one touch sensitive button on the electronic device;
displaying a pre-recorded representation of the first site on the electronic device; and
a remote user activating the at least one touch sensitive button to interact with the pre-recorded representation of the first site.

38. A method of remote interaction comprising the steps of:
providing, at a first site, at least one image capturing device having an optical sensor and being operably connected to an electronic communication point capable of being connected to a communication network;
providing, at a second site, an electronic device capable of accessing the communication network;
displaying at least one touch sensitive button on the electronic device;
displaying a live representation of the first site on the electronic device; and
a remote user activating the at least one touch sensitive button to interact with the live representation of the first site.

39. A method of remote interaction comprising the steps of:
providing, a time varying image or static image,
wherein the time varying or static image is pre-recorded or streamed in real time;
providing, an electronic device capable of accessing the time varying image or static image over a communication network;
providing, at least one touch sensitive surface on the electronic device; and
a user using the at least one touch sensitive surface to cause a response in the time varying image or static image.
